(19) United States
(12) Patent Application Publication
(10) Pub. No.: US 2005/0094314 A1
(43) Pub. Date: May 5, 2005

(54) Magnetic head

(75) Inventor: Shinji Sugihara, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 10/963,338

(22) Filed: Oct. 12, 2004

(30) Foreign Application Priority Data
Oct. 31, 2003 (JP) 2003-371801
Mar. 31, 2004 (JP) 2004-105605

(51) Int. Cl. G11B 5/127

(52) U.S. Cl. 360/125

(57) ABSTRACT

In a magnetic head, a magnetic core is formed by joining core halves. The magnetic core includes first stepped portions, second stepped portions, and a narrow core portion. A magnetic gap is provided in the narrow core portion. A terminal end of the magnetic gap is disposed between the second stepped portion and the narrow core portion, and the depth of the magnetic gap is thereby made small. The magnetic gap is reinforced by nonmagnetic material portions on both sides thereof, and a nonmagnetic material.

### BACKGROUND OF THE INVENTION

1. Field of the Invention

The present invention relates to magnetic heads for use in magnetic recording and playback apparatuses such as digital video cameras (DVCs) and tape storages, and more particularly, to a magnetic head having a small track width that is suitable for high-density recording, that constantly touches a tape in a proper manner, and that provides stable playback output performance.

2. Description of the Related Art The recording density of magnetic recording and playback apparatuses, such as digital video cameras and tape storages, has increased, and correspondingly, the track width of magnetic heads mounted in the magnetic recording and playback apparatuses has decreased.

In a narrow-track magnetic head, the width (thickness) of a portion of a magnetic core that appears on a sliding surface that slides on a recording medium must be decreased in accordance with the track width.

U.S. Pat. No. 5,157,569 discloses a magnetic head having a narrow track width. The magnetic head is shown in FIG. 8.

A magnetic core 1 of the magnetic head shown in FIG. 8 is formed by joining core halves 2 and 3 made of a magnetic material. First stepped portions 4 are provided on both side faces of an upper part of the magnetic core 1 in the figure, and second stepped portions 5 are provided on the upper sides of the first stepped portions 4. In this specification, the thickness in the X-direction of the magnetic core 1 refers to the width. The width of the magnetic core 1 decreases between the first stepped portions 4 and the second stepped portions 5, and further decreases from the second stepped portions 5 toward a narrow core portion 5.

Nonmagnetic material portions 7 made of, for example, glass are provided on both sides of the narrow core portion 6. Leading end faces of the narrow core portion 6 and the nonmagnetic material portions 7 appear on a sliding surface that slides on a recording medium.

An opening 8 used to wind a coil is provided between the core halves 2 and 3. On a side of the opening 8 closer to the first stepped portions 4, the core halves 2 and 3 are joined by a nonmagnetic material, such as glass, to define a magnetic gap G. A starting end Ga of the magnetic gap G appears on the sliding surface, and a terminal end Gb thereof is disposed at a border with the first stepped portions 4. The terminal end Gb is disposed offset from the first stepped portions 4 toward a base end of the magnetic core 1.

Japanese Unexamined Patent Application Publication No. 59-14115 also discloses a magnetic head having stepped portions on side faces of a magnetic core. In this magnetic head, the magnetic core has one pair of stepped portions, and nonmagnetic material portions made of a nonmagnetic material, such as glass, extend from the stepped portions toward a tape contact surface on both sides of the magnetic core.

In the magnetic head disclosed in U.S. Pat. No. 5,157,569, the leading end of the opening 8 is disposed offset from the first stepped portions 4 toward the base end of the magnetic core 1, and the terminal end Gb of the magnetic gap G is disposed offset from the first stepped portions 4 toward the base end and in a wide portion of the magnetic core 1. By thus placing the terminal end Gb in the wide portion of the magnetic core 1, the magnetic gap G is prevented from being damaged in the narrow core portion 6. In this structure, however, the depth Gd of the magnetic gap G is too large, the strength of a leakage field applied from the starting end Ga of the magnetic gap G to the recording medium is small, and, for example, overwriting performance is reduced.

In order to reduce the gap depth Gd in the structure shown in FIG. 8, the first stepped portions 4 and the second stepped portions 5 may be shifted to higher positions. In this case, however, edges 4a and 5a of the stepped portions 4 and 5 appearing on the sliding surface are placed closer to the starting end Ga of the magnetic gap G, and the probability that the edges 4a and 5a will touch the recording medium is increased. Consequently, the recording medium is prone to be damaged.

In the magnetic head disclosed in the above Japanese publication, one pair of stepped portions is provided on the side faces of the magnetic core, and the nonmagnetic material portions extend from the stepped portions. This magnetic head does not aim to reduce the track width of the magnetic head, but aims to increase wear resistance by exposing the nonmagnetic material portions from the sliding surface.

When only one pair of stepped portions is provided, as in this magnetic head, it is impossible to sufficiently reduce the track width. If an attempt is made to reduce the track width with one pair of stepped portions, the width of the magnetic core becomes too small, saturation magnetic flux is reduced, and current-magnetic conversion efficiency is reduced.

Furthermore, since the nonmagnetic material portions extend from the stepped portions toward the tape contact surface, the width of the sliding surface is equal to the width of the magnetic core. For this reason, a sliding area between the sliding surface and the recording medium is large. Consequently, the recording medium is easily damaged, and magnetic powder falling off the recording medium is prone to adhere to the sliding surface.

### SUMMARY OF THE INVENTION

In view of the above-described problems, an object of the present invention is to provide a magnetic head that provides a magnetic gap with a narrow track width by sufficiently reducing the width of a portion of a core appearing on a sliding surface in order to achieve higher-density recording, that provides high recording and reproducing performance, and that properly slides on a recording medium.

In order to achieve the above object, according to an aspect, the present invention provides a magnetic head having a magnetic core formed by joining a pair of core halves made of a magnetic material. The magnetic core includes a joint portion between the core halves; a sliding surface provided at a first end of the magnetic core so as to slide on a recording medium; a bottom face provided at a second end of the magnetic core; first stepped portions provided on both side faces of the magnetic core at a predetermined distance from the first end toward the bottom face; second stepped portions provided offset from the first stepped portions toward the first end; a narrow core portion provided offset from the second stepped portions toward the first end; and nonmagnetic material portions provided on both sides of the narrow core portion. The width of the magnetic core decreases from the first stepped portions toward the first end, and further decreases from the second stepped portions toward the first end to define the narrow core portion. A magnetic gap is provided at the joint portion so as to appear on the sliding surface, and includes a starting end on the sliding surface, and a terminal end between the sliding surface and the second stepped portions.

Since the narrow core portion is provided offset from the two pairs of stepped portions toward the first end of the magnetic core, the magnetic head can be worked so that the width of the narrow core portion is extremely small. Moreover, since the terminal end of the magnetic gap is disposed between the second stepped portions and the sliding surface, the depth of the magnetic gap can be reduced, and the strength of a leakage field applied to the recording medium can be increased.

Preferably, the nonmagnetic material portions are joined to both sides of the magnetic gap, and a nonmagnetic material is joined to the terminal end of the magnetic gap from the side of the second end.

The terminal end of the magnetic gap in the depth direction is disposed between the second stepped portions and the sliding surface, and therefore, the magnetic gap is shallow. However, since the nonmagnetic material portions are provided on both sides of the narrow core portion, and the nonmagnetic material is also provided on the side of the terminal end of the magnetic gap close to the bottom face, the magnetic gap provided in the narrow core portion can be reinforced, and the narrow core portion can be prevented from being damaged around the magnetic gap.

Preferably, the nonmagnetic material portions are made of glass, and the nonmagnetic material is also made of glass.

Preferably, the sliding surface is convex so as to protrude at a portion on which the magnetic gap appears, and extends toward the second end beyond the second stepped portions.

Since the terminal end of the magnetic gap is disposed between the second stepped portions and the sliding surface, even when the first and second stepped portions are shifted toward the second end of the magnetic core, the depth of the magnetic gap is not influenced thereby. Therefore, edges of the stepped portions appearing on the sliding surface can be disposed apart from the starting end of the magnetic gap. This can prevent the edges from damaging the recording medium.

Preferably, a leading end face of the narrow core portion protrudes from leading end faces of the nonmagnetic material portions on the sliding surface.

In this case, in a cross section taken along a plane crossing the sliding surface and disposed orthogonal to the both side faces, the leading end faces of the nonmagnetic material portions are shaped like a convex curve, both corners of the leading end face of the narrow core portion are shaped like a convex curve, and the radius of curvature of the convex curve of the corners is smaller than that of the leading end faces of the nonmagnetic material portions.

Since the leading end face of the narrow core portion protrudes upward from the leading end faces of the nonmagnetic material portions, and the leading end faces of the nonmagnetic material portions are curved, spacing between the recording medium and the magnetic gap is stabilized, and stable playback output performance can be achieved.

Preferably, the sum of the width of the narrow core portion and the widths of the nonmagnetic material portions is within the range of 40 μm to 80 μm.

Since the magnetic core has the first and second stepped portions, the narrow core portion offset from the second stepped portions toward the first end of the magnetic core can be worked to be narrow, and the track width of the magnetic gap can be reduced. Moreover, since the terminal end of the magnetic gap is disposed between the second stepped portions between the sliding surface, the depth of the magnetic gap can be reduced, and the strength of a magnetic field applied to the recording medium can be increased. Although the magnetic gap is provided in the narrow core portion, since both sides and the terminal end of the magnetic gap are reinforced by the nonmagnetic materials, the narrow core portion can be easily prevented from being damaged around the magnetic gap.

It is also possible to stabilize the sliding performance between the sliding surface of the magnetic core and the recording medium, and to reduce a spacing loss.

### BRIEF DESCRIPTION OF THE DRAWINGS

FIG. 1 is a perspective view of a magnetic head according to an embodiment of the present invention;

FIG. 2 is a top plan view of a sliding surface of the magnetic head shown in FIG. 1 that slides on a recording medium;

FIG. 3 is a side view of the magnetic head shown in FIG. 1;

FIG. 4 is an enlarged sectional view of the magnetic head shown in FIG. 1, taken along a plane passing through a starting end of a magnetic gap and disposed perpendicular to side faces;

FIG. 5 is a graph showing the relationship between the width of the sliding surface and a playback output envelope measured with a magnetic head as an example and a magnetic head as a comparative example;

FIG. 6 is a plot diagram showing the surface shape of the sliding surface of the magnetic head as the example measured by phase-shift interferometry;

FIG. 7 is a perspective view of the magnetic head as the comparative example; and

FIG. 8 is a perspective view of a conventional magnetic head.

### DESCRIPTION OF THE PREFERRED EMBODIMENTS

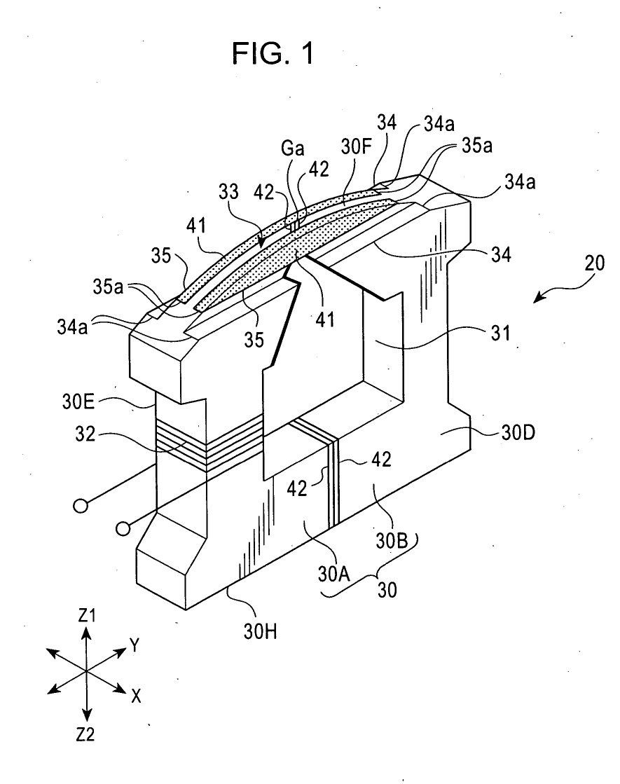

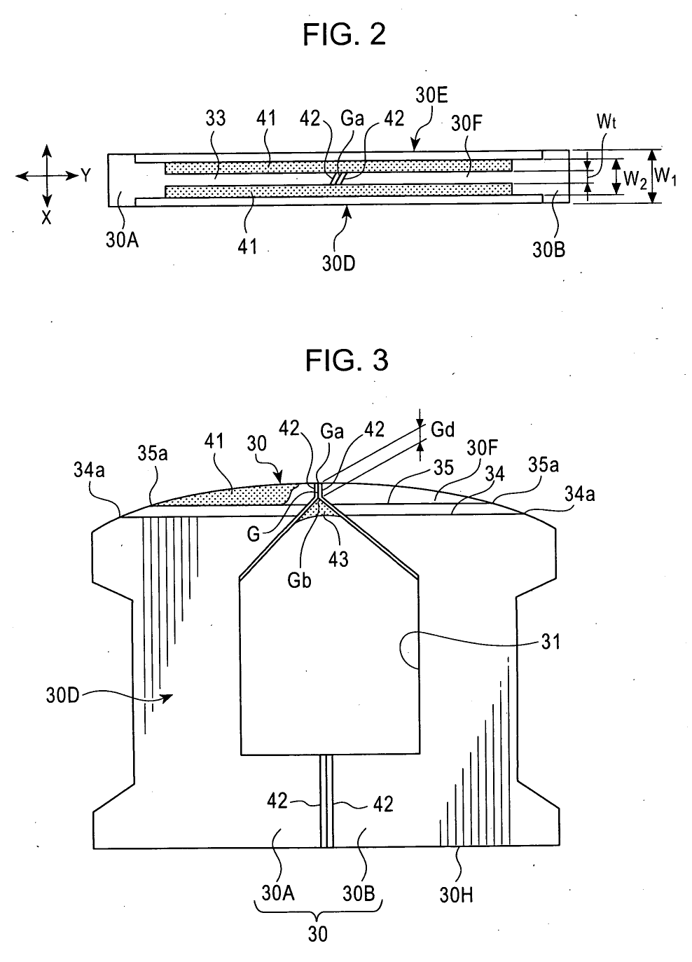

FIG. 1 is a perspective view of a magnetic head according to an embodiment of the present invention, FIG. 2 is a top plan view of a sliding surface of the magnetic head that slides on a recording medium, and FIG. 3 is a side view of the magnetic head.

A magnetic head 20 shown in FIG. 1 is mounted in a magnetic recording and playback apparatus of a digital video camera (DVC). The magnetic head 20 is disposed on the outer periphery of a rotating drum. In the magnetic recording and playback apparatus, a magnetic tape serving as a recording medium is moved while being helically wound on the rotating drum, and the magnetic head 20 obliquely slides on a recording surface of the magnetic tape while the rotating drum rotates.

In FIG. 1, the Y-direction represents the rotating direction of the rotating drum, that is, the direction of sliding of the magnetic head 20 on the magnetic tape. In this specification, the X-direction orthogonal to the Y-direction represents the width direction of the magnetic head 20, the Z1-direction represents the direction toward a first end (upper end in the figure) of the magnetic head 20, and the Z2-direction represents the direction toward a second end (lower end in the figure) of the magnetic head 20.

The magnetic head 20 includes a magnetic core 30. The magnetic core 30 has a sliding surface 33, which slides on a magnetic tape, at its first end (Z1-side), and a flat bottom face 30H provided along an X-Y plane at its second end (Z2-side). The sliding surface 33 is formed by lapping the first end of the magnetic core 30, and is a curved surface having a fixed curvature in the scanning direction (Y-direction) for the magnetic tape.

The magnetic core 30 is formed by joining core halves 30A and 30B made of single-crystal ferrite. The magnetic core 30 is thin in the X-direction, and has side faces 30D and 30E having a large area on the X-direction surfaces. An opening 31 is provided through the side faces 30D and 30E in the width direction (X-direction). A lead is wound through the opening 31 to form a coil 32.

The side faces 30D and 30E of the magnetic core 30 have first stepped portions 34, and second stepped portions 35 provided offset from the first stepped portions 34 toward the first end of the magnetic core 30. The width of the magnetic core 30 decreases between the first stepped portions 34 and the second stepped portions 35, and further decreases between the second stepped portions 35 and the first end, thereby forming a narrow core portion 30F.

Nonmagnetic material portions 41 made of a nonmagnetic material such as glass (SiO₂) are provided in tight contact with both sides of the narrow core portion 30F.

FIG. 2 shows the widths of the above-described portions. In FIG. 2, W₁ represents the width of the entire magnetic core 30 (the width of a portion having the opening 31), W₂ represents the width of a portion offset from the first stepped portions 34 toward the first end of the magnetic core 30, and is smaller than the width W₁, and Wₜ represents the width of the narrow core portion 30F. Since a starting end Ga of a magnetic gap G appears on the surface of the narrow core portion 30F, as will be described later, the apparent width of a recording track of data recorded on a magnetic tape with the magnetic gap G is equal to the width Wₜ. The actual width of a recording track width of data recorded on the magnetic tape is not always equal to the width Wₜ, but is slightly larger than Wₜ.

The narrow core portion 30F and the nonmagnetic material portions 41 on both sides thereof appear on the sliding surface 33 of the magnetic core 30. The width of the sliding surface 33 is equal to the sum of the widths of the narrow core portion 30F and the nonmagnetic material portions 41, and is substantially equal to the above-described width W₂.

The magnetic head 20 achieves high-density recording on the magnetic tape. The width of the narrow core portion 30F (apparent track width) Wₜ is approximately 5 μm to 20 μm. In this case, the width W₂ is within the range of 40 μm to 80 μm, preferably within the range of 40 μm to 70 μm, and more preferably, within the range of 40 μm to 55 μm. The width W₁ is approximately 100 μm to 200 μm.

In a production process for the magnetic core 30, a block assembly is formed by joining a pair of opposing magnetic blocks, which are long in the X-direction and are used to form the core halves 30A and 30B, by an adhesive nonmagnetic material such as glass (SiO₂). Grooves are formed on both sides of a leading end of the block assembly to define the narrow core portion 30F, and the grooves are filled with a nonmagnetic material such as glass. The leading end of the block assembly is lapped into the shape of the sliding surface 33. Subsequently, deeper grooves are formed in the nonmagnetic materials filled in the grooves, thus forming the first stepped portions 34 and the second stepped portions 35. The block assembly is then cut between the first stepped portions 30 to form separate magnetic cores 30.

FIG. 3 is a side view of the magnetic core 30, as viewed from the side face 30D. In FIG. 3, the shown nonmagnetic material portion 41 is partly removed in order to easily understand the position and shape of the magnetic gap G between the core halves 30A and 30B.

As shown in FIG. 3, at the first end of the magnetic core 30, magnetic metal films 42 made of a metal having high saturation density, such as sendust, are provided on joint faces of the core halves 30A and 30B at the narrow core portion 30F, so that the magnetic head has an MIG (metal-in-gap) structure. The nonmagnetic metal films 42 of the core halves 30A and 30B are joined by an adhesive nonmagnetic material such as glass, and the joint therebetween at the narrow core portion 30F serves as the magnetic gap G.

A starting end Ga of the magnetic gap G appears in the surface of the narrow core portion 30F on the sliding surface 33, and the apparent track width can be set at Wₜ. A terminal end Gb of the magnetic gap G is provided at a border with the opening 31. The terminal end Gb is provided between the second stepped portions 35 and the sliding surface 33, and the magnetic gap G is defined only by the narrow core portion 30F.

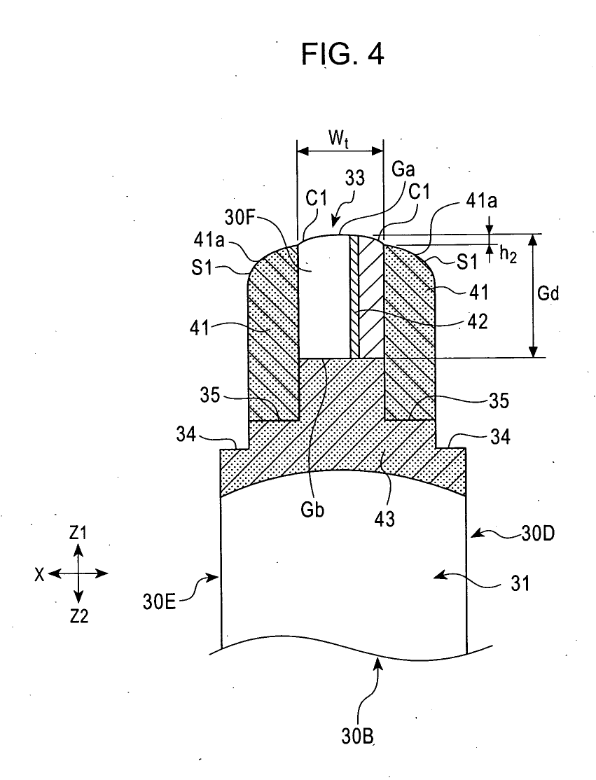

As shown in FIGS. 3 and 4, an adhesive nonmagnetic material 43 such as glass is in tight contact with the top of the opening 31, and a portion of the terminal end Gb of the magnetic gap G opposing the opening 31 (facing toward the second end of the magnetic core 30) is entirely covered with the nonmagnetic material 43. That is, both sides in the X-direction of the magnetic gap G provided in the narrow core portion 30F are reinforced by the nonmagnetic material portions 41 made of an adhesive magnetic material, and the terminal end Gb is reinforced by the nonmagnetic material 43 provided in the opening 31. For this reason, even when the depth (gap depth) Gd between the starting end Ga and the terminal end Gb of the magnetic gap G is extremely small, the magnetic gap G will not be broken by, for example, a frictional force caused by sliding on the magnetic tape.

The nonmagnetic material 43 may be supplied in a step different from that for the nonmagnetic material of the nonmagnetic material portions 41, or may be supplied by guiding a part of the nonmagnetic material of the nonmagnetic material portions 41 to the top of the opening 31.

By decreasing the gap depth Gd, as described above, a magnetic flux can be concentrated to the starting end Ga of the magnetic gap G, the strength of a leakage field from the starting end Ga can be increased, and for example, overwriting performance can be enhanced.

The magnetic metal films 42 are also provided on the opposing surfaces of the core halves 30A and 30B under the opening 31 of the magnetic core 30, and are bonded by an adhesive nonmagnetic material layer made of, for example, glass.

As shown in FIGS. 1 to 3, the sliding surface 33 shaped like a convex face curved in the Y-direction is provided at the top of the magnetic core 30. Since the first stepped portions 34 and the second stepped portions 35 are provided in the magnetic core 30, the curved sliding surface 33 extends toward the bottom face 30H beyond the second stepped portions 35. As a result, edges 34a of the first stepped portions 34 and edges 35a of the second stepped portions 35 appear on the sliding surface 33.

In the magnetic core 30, the terminal end Gb of the magnetic gap G is disposed between the second stepped portions 35 and the sliding surface 33, and the magnetic gap G is reinforced by the nonmagnetic material portions 35 and the nonmagnetic material 43. Therefore, even when the second stepped portions 35 and the first stepped portions 34 are disposed as close to the bottom face 30H as possible, this does not adversely affect the shape and depth Gd of the magnetic gap G.

By placing the second stepped portions 35 and the first stepped portions 34 as close to the bottom face 30H as possible, the edges 34a and the edges 35a appearing on the sliding surface 33 can be disposed apart from the starting end Ga at the top of the curve of the sliding surface 33. Alternatively, these edges can be placed so as not to be exposed from the outer peripheral surface of the rotating drum. Consequently, the probability that the edges 34a and 35a will touch and damage the magnetic tape can be reduced.

As shown in FIG. 4, the sliding surface 33 is defined by an upper surface of the narrow core portion 30F and upper surfaces 41a of the nonmagnetic material portions 41. The upper surface of the narrow core portion 30F protrudes upward by h2 from the upper surfaces 41a of the nonmagnetic material portions 41. In this specification, the “upward” direction refers to the Z1-direction in the figure that approaches the magnetic tape.

The upper surfaces 41a of the nonmagnetic material portions 41 are convex faces that gradually approach the second end of the magnetic core 30 away from both side faces of the narrow core portion 30F in the sideward direction (X-direction). These convex faces are denoted by S1 in FIG. 4.

Since the upper surface of the narrow core portion 30F. on which the starting end Ga of the magnetic gap G appears protrudes upward from the upper surfaces 31a of the nonmagnetic material portions 41 in this way, the starting end Ga can properly touch the magnetic tape. When this magnetic head 20 is mounted in the rotating drum and slides on the magnetic tape with the rotation of the rotating drum, a spacing loss between the starting end Ga and the magnetic tape can be removed, and recording and playback performance can be enhanced.

As shown in FIG. 4, convex faces C1 are provided at least on both sides of the upper surface of the narrow core portion 30F. Since the convex faces C1 are provided on the narrow core portion 30F and the convex faces S1 are provided on the nonmagnetic material portions 41, the sliding surface 33 slides on the magnetic tape without damaging the magnetic tape, and the starting end Ga of the magnetic gap G can stably slide on the magnetic tape.

Since the sliding surface 33 of the magnetic head 20 slightly protrudes from the outer peripheral surface of the rotating drum, the magnetic tape sometimes deforms by the contact with the sliding surface 33 so as to conform to the shape of the sliding surface 33. By setting the average radius of curvature of the convex faces C1 of the narrow core portion 30F to be smaller than the average radius of curvature of the convex faces S1 of the nonmagnetic material portions 41, the upper surface of the narrow core portion 30F. easily touches the magnetic tape over the entire width Wₜ, and the starting end Ga of the magnetic gap G properly touches the magnetic tape even when the magnetic tape deforms.

The average radius of curvature refers to the value obtained by dividing the integral value of the curvature in a short area of a curve, which serves as an edge line of the convex faces C1 or S1, by the length of the curve, as viewed in a cross section passing through the sliding surface 33 and disposed perpendicular to the side faces 30D and 30E, as shown in FIG. 4.

The magnetic head 20 of the embodiment shown in FIGS. 1 to 4 and a magnetic head 60 as a comparative example were mounted in the rotating drum. In a magnetic recording and playback apparatus having the rotating drum, a magnetic tape is helically wound around the rotating drum, and the sliding surface of the magnetic head 20 or 60 scans the magnetic tape in a direction diagonal to the tape running direction with the rotation of the rotating drum.

### EXAMPLE

A plurality of magnetic heads similar to the magnetic head 20 shown in FIGS. 1 to 4. The width Wₜ of the narrow core portion 30F, that is, the apparent track width was fixed, and the width W₂ of the sliding surface 33 was varied among the magnetic heads by changing the width of the nonmagnetic material portions 41. The width W₂ of the sliding surface 33 was equal to the sum of the width of the narrow core portion 30F and the widths of the nonmagnetic material portions 41.

### Comparative Example

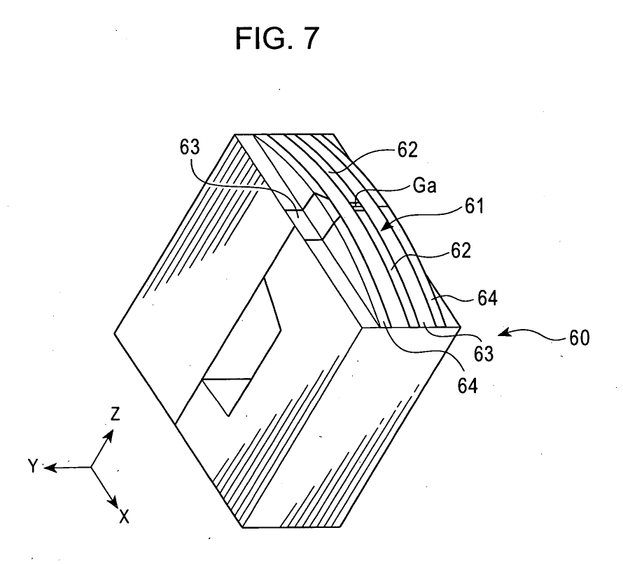

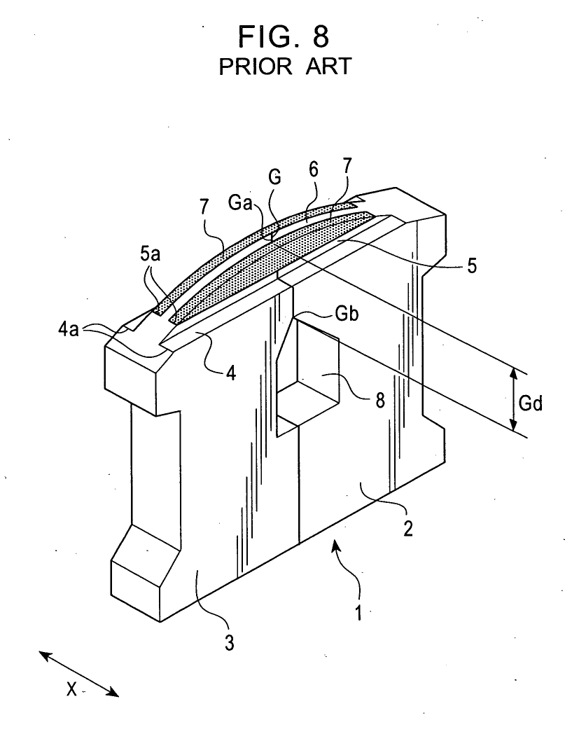

A magnetic head 60 shown in FIG. 7 was produced. In the magnetic head 60, a sliding surface 61 included a narrow core portion 62 on which a starting end Ga of a magnetic gap G appeared. Nonmagnetic material portions 63 were provided on both sides of the narrow core portion 62, and side core portions 64 were formed of portions of a magnetic core on both sides of the nonmagnetic material portions 63. The curvature of a curve in the X-direction of the sliding surface 61 was set to be equal to that in the magnetic head 20 of the example. The material of the magnetic core and the nonmagnetic material were the same as those in the example, and the thickness and material of magnetic metal films opposing at the magnetic gap G, and the depth Gd of the magnetic gap G were also the same as those in the example.

A plurality of magnetic heads similar to the magnetic head 60 as the comparative example were produced. The width of the narrow core portion 62 was fixed at 12 μm, as in the example, and the sum of the widths of the narrow core portion 62, the nonmagnetic material portions 63, and the side core portions 64 was varied among the magnetic heads.

[Measurement Method A]

Magnetic information recorded on a magnetic tape was played back by the magnetic recording and playback apparatus. When the magnetic head 20 or 60 scanned a predetermined track recorded on the magnetic tape, the strength of an initial playback output obtained at the beginning of scanning and the strength-of a terminal playback output obtained at the end of scanning were measured, and the ratio (percentage) of the strength of the terminal playback output to the strength of the initial playback output was calculated. The ratio refers to the rate of change of the strength of a playback envelope when the magnetic head scans the predetermined track, conversely, the maintenance rate of the strength.

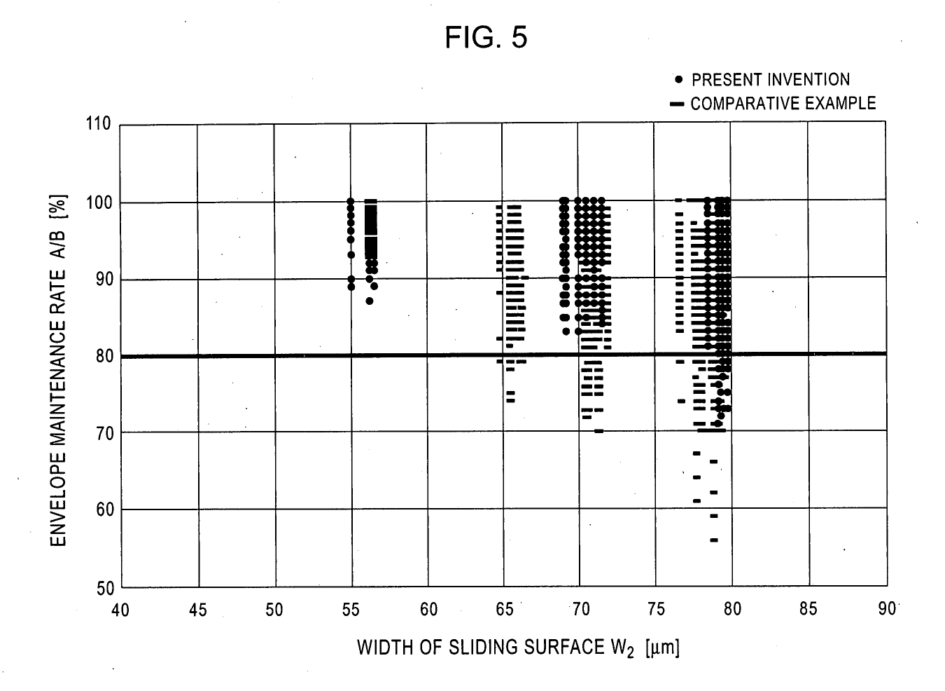

FIG. 5 shows the ratio (maintenance rate of the envelope strength) after measurement. In FIG. 5, the horizontal axis indicates the width of the sliding surface (W₂ in the embodiment), and the vertical axis indicates the maintenance rate of the envelope strength. Measurement results of the magnetic heads 20 as the example are shown by dots, and measurement results of the magnetic heads as the comparative example are shown by bars. One dot and one bar each correspond to one sample result.

FIG. 5 shows that the envelope maintenance rate of the playback output increases as the width (W₂ in the embodiment) of the sliding surface opposing the magnetic tape decreases. When the width of the sliding surface is fixed, the maintenance rate of the envelope strength of the magnetic head 20 is higher than that of the magnetic head 60. Further, the maintenance rate in the example less widely varies than in the comparative example.

As shown in FIG. 5, in the magnetic head 20 of the example, when the width W₂ of the sliding surface 33 opposing the magnetic tape is 80 μm or less, the maintenance rate of the envelope strength can be set high. When the width W₂ is 70 μm or less, the maintenance rates of the envelope strength in all the samples are 80% or more. When the width W₂ is 55 μm or less, the maintenance rates in all the samples are 85% or more.

However, when the width W₂ is less than 40 μm, the mechanical strength of the magnetic head extremely decreases. Therefore, it is preferable that the lower limit of the width W₂ be 40 μm.

[Measurement Method B]

Next, the surface shapes of the convex faces Cl and the convex faces S1 shown in FIG. 4 were compared in the sample used in the example in which the width W₂ of the sliding surface 33 was 80 μm.

Phase-shift interferometry as a kind of optical interferometry was used for measurement. A phase difference between reflected light from a reference surface and measuring light having a wavelength λ and reflected from the sliding surface 33 of the magnetic head 20 was calculated by using an interferometer. The height h of the sliding surface 33 from the reference surface was given by (λ/4π) ·Φ.

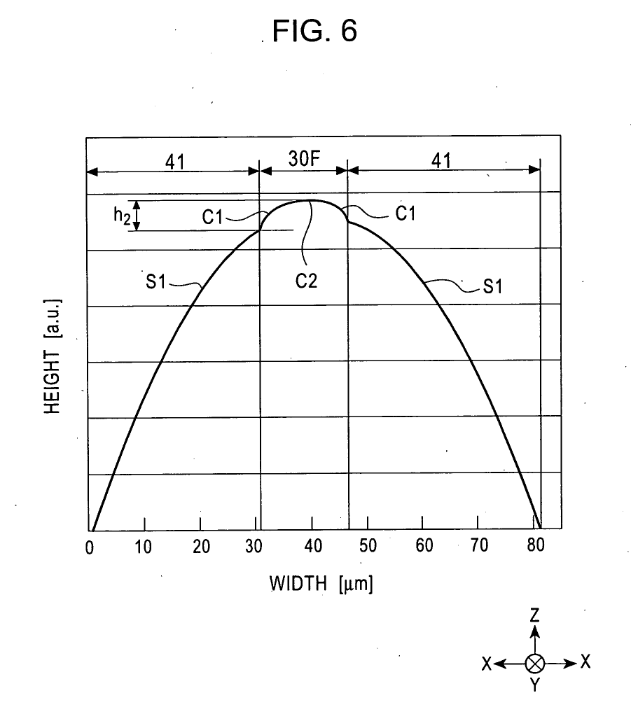

FIG. 6 shows the surface shape of the sliding surface 33 in the sample that is graphically expressed by phase-shift interferometry. The measurement by phase-shift interferometry was taken with Wyco HD2000 #2 from Veeco Instruments Inc. The measurement point was disposed 150 μm apart from the starting end Ga on a side of the sliding surface 33 that touches the magnetic tape earlier than the starting end Ga. FIG. 6 shows the shape of an edge line that appears on the sliding surface in the cross section of the magnetic head.

Referring to FIG. 6, in this sample, the upper surface of the narrow core portion 30F protrudes from the upper surfaces 41a of the nonmagnetic material portions 41, and the height h₂ thereof is within the range of 5 nm to 40 nm. The average radius of curvature of the convex faces C1 is smaller than that of the convex faces S1.

It can be understood that the performance of the example is high, as in FIG. 5, because the sliding surface 33 has the surface shape shown in FIG. 6.

1. A magnetic head having a magnetic core formed by joining a pair of core halves made of a magnetic material,
wherein the magnetic core comprises:
a joint portion between the core halves;
a sliding surface provided at a first end of the magnetic core so as to slide on a recording medium;
a bottom face provided at a second end of the magnetic core;
first stepped portions provided on both side faces of the magnetic core at a predetermined distance from the first end toward the bottom face;
second stepped portions provided offset from the first stepped portions toward the first end;
a narrow core portion provided offset from the second stepped portions toward the first end; and
nonmagnetic material portions provided on both sides of the narrow core portion,
wherein the width of the magnetic core decreases from the first stepped portions toward the first end, and further decreases from the second stepped portions toward the first end to define the narrow core portion, and
wherein a magnetic gap is provided at the joint portion so as to appear on the sliding surface, and includes a starting end on the sliding surface, and a terminal end between the sliding surface and the second stepped portions.

2. The magnetic head according to claim 1, wherein the nonmagnetic material portions are joined to both sides of the magnetic gap, and a nonmagnetic material is joined to a side of the terminal end of the magnetic gap close to the second end.

3. The magnetic head according to claim 2, wherein the nonmagnetic material portions are made of glass, and the nonmagnetic material is also made of glass.

4. The magnetic head according to claim 1, wherein the sliding surface is convex so as to protrude at a portion on which the magnetic gap appears, and extends toward the second end beyond the second stepped portions.

5. The magnetic head according to claim 1, wherein a leading end face of the narrow core portion protrudes from leading end faces of the nonmagnetic material portions on the sliding surface.

6. The magnetic head according to claim 1, wherein, in a cross section taken along a plane crossing the sliding surface and disposed orthogonal to the side faces, leading end faces of the nonmagnetic material portions are shaped like a convex curve.

7. The magnetic head according to claim 6, wherein both corners of a leading end face of the narrow core portion are shaped like a convex curve in the cross section, and the radius of curvature of the convex curve of the corners is smaller than that of the leading end faces of the nonmagnetic material portions.

8. The magnetic head according to claim 1, wherein the sum of the width of the narrow core portion and the widths of the nonmagnetic material portions is within the range of 40 μm to 80 μm.
